(19) United States
(12) Patent Application Publication
(10) Pub. No.: US 2006/0152087 A1
(43) Pub. Date: Jul. 13, 2006

(54) Embedded computing system with reconfigurable power supply and/or clock frequency domains

(76) Inventors: Bernardo De Oliverira Kastrup Pereira, Eindhoven (NL); Jozef Louis Van Meerbergen, Eindhoven (NL); Josephus Antonius Huisken, Eindhoven (NL); Alexander Augusteijn, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/559,209

(22) PCT Filed: May 28, 2004
(86) PCT No.: PCT/IB04/50800

§ 371 Date: Dec. 6, 2005

(30) Foreign Application Priority Data
Jun. 10, 2003 (EP) 03101677.7

(51) Int. Cl. H02B 1/24

(52) U.S. Cl. 307/112

(57) ABSTRACT

The present invention provides a method and device for reconfiguring an embedded computing system during its lifetime, so that optimal trade-offs between performance and energy consumption can be achieved. An embedded computing system (10) according to the present invention comprises a plurality of domains, each domain (80, 82) comprising at least one processing element (12), each domain (80, 82) operating at a utility supply value, one domain (80, 82) having a first utility supply value. Each processing element (12) of the one domain is provided with a reconfiguration device for independently changing the utility supply value to a second utility supply value for the one domain.

The present invention relates to embedded computing systems, where multiple processing elements treat different parts of an application in the context of an interconnected structure. Embedded computing systems can be found in almost all types of electronic consumer appliances such as intelligent TV sets, beverage machines or refrigerators for example. These devices have embedded microprocessors that allow various functions such as access to intelligent networks and retrieval of both relevant information and services. Typical embedded computing applications include machine automation, machine vision, mass transportation, radar and high-speed data acquisition.

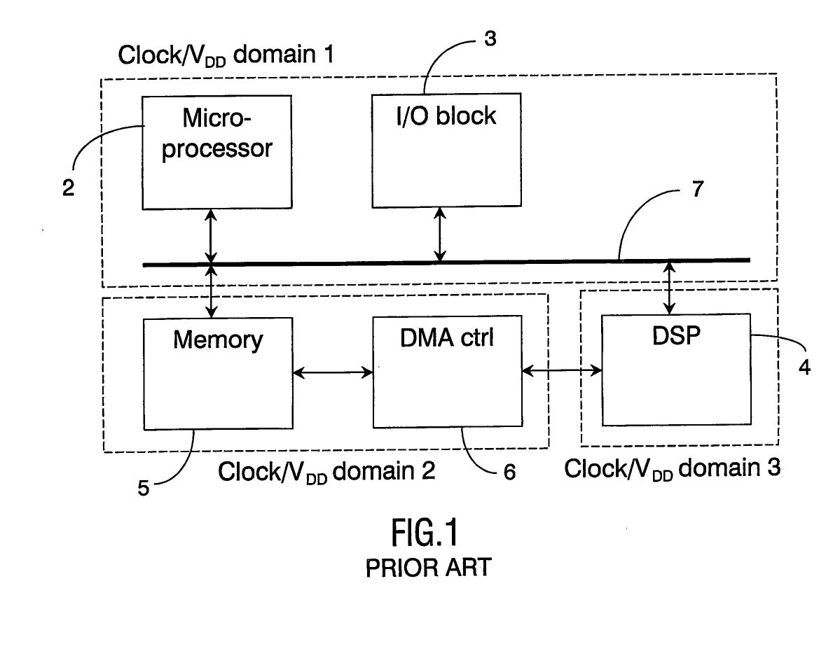

In state-of-the-art embedded computing systems, i.e. computing systems embedded within electronic devices, also called system-on-chip or SoC, heterogeneous processing elements are placed within a system, typically connected via a main system bus 7, as represented in FIG. 1. The processing elements may be any types of circuits, such as for example, but not limited thereto, micro-controllers or microprocessors 2 with input/output (I/O) blocks 3, digital signal processors (DSPs) 4, application specific integrated circuit (ASIC) cores, memories 5, direct memory access controllers (DMA ctrl) 6, logic circuits, etc.

A clock frequency and power supply value V_{DD} may be associated with each processing element. Processing elements with a same clock frequency and power supply value V_{DD} form a domain. It is advantageous that the clock frequency and/or the power supply value V_{DD} associated with different domains of processing elements is different, so that appropriate trade-offs of power dissipation and performance can be made in different parts of the system. This leads to the creation of multiple clock and V_{DD} domains within one system, as represented in FIG. 1. In FIG. 1, three such domains are represented.

In terms of manufacturing processes, it is becoming increasingly difficult to ensure that a uniform clock and V_{DD} signal are provided to all parts of the system, so multiple domains are again useful. However, in the prior art, the clock and V_{DD} domains are fixed, hard-wired e.g. in silicon. They can't be changed after device fabrication anymore.

U.S. Pat. No. 6,384,628 describes a programmable logic device (PLD). The PLD has different inputs for receiving different power supply levels, e.g. supply voltages, each power supply level being directed to a part of the PLD, for example a first supply voltage being directed to a voltage regulator of the PLD and to a programmable logic portion thereof, a second supply voltage being directed to an input circuit and a third supply voltage being directed to an output circuit. The voltage regulator and programmable logic portion, the input circuit, and the output circuit each define a V_{DD} domain, i.e. they are processing elements running on a different power supply level. Although different domains of the PLD receive different power supply voltages, each domain receives the same supply voltage throughout its lifetime, as hard-wired at the moment of fabrication.

Different applications, or even different modes of usage of a device, throughout its lifetime, could mean that a performance/power trade-off, different from the one enforced by the fixed clock and V_{DD} domain distribution, would be more efficient. For this reason, it would be of advantage if the configuration of domains could be changed after fabrication, in a flexible way. This, however, is not possible with the prior art.

It is an object of the present invention to overcome the disadvantage of the prior art. More particularly, it is an object of the present invention to provide an embedded computing system with reconfigurable power supply and/or clock frequency domains, i.e. where a domain can receive different power supply levels, e.g. supply voltages or supply currents, throughout it's lifetime.

The above objective is accomplished by a device and method according to the present invention.

The present invention provides an embedded computing system comprising a plurality of domains, each domain comprising at least one processing element, each domain is operating at a utility supply value, one domain having a first utility supply value. Each processing element of the one domain is provided with a reconfiguration device for independently changing the utility supply value to a second utility supply value for the one domain. With utility supply value is meant a basic function required for operation, but not for configuration of the circuit. Power, voltage or current, and clock signals are examples of a utility supply value. Data, for example, which is a payload of the system, is not considered a utility supply value. In other words, a utility supply value is a non-configuring, non-payload consumable of an electronic circuit; it is a consumable required to make an electronic especially a digital system work. It is an advantage of such a system that optimal trade-offs between performance and energy consumption can be achieved during the lifetime of the embedded computing system.

In an embedded computing system according to the present invention, the utility supply value may be a power supply value, i.e. a voltage level or a current level. A plurality of power supply rails may carry power with different power supply values to the processing elements of at least one of the domains. Each processing element of the at least one domain is then provided with a switching element for independently making a connection to a power supply rail to change the power supply value to a second power supply value. The switching element may be a transistor. Such transistor is easy to integrate in a processing element which is often a semiconductor device.

Additionally, or alternatively, in an embedded computing system according to the present invention, the utility supply value may be a clock signal. The computing system may comprise a global reference clock line carrying a reference clock signal to the processing elements of at least one of the domains. Each processing element of the at least one domain may be provided with a frequency adapter for generating from the reference clock signal a first internal operating clock signal for the one domain. According to the present invention, the frequency adapter is reconfigurable for independently generating from the reference clock signal a second internal operating clock signal during the lifetime of the embedded computing system. The reconfigurable frequency adapter may for example be a phase locked loop (PLL). A PLL will generate an internal clock signal that has the same phase as the reference clock signal, as desired. It is to be noted that the reference signal basically sets a phase reference, so PLL's are ideal for guaranteeing that phase reference is maintained. In addition, because PLL's can multiply the incoming reference signal so as to generate a higher frequency, only the lowest of all frequencies required needs to be transmitted through the entire system as a reference, therefore decreasing total power dissipation, since the higher frequencies may all be generated and used locally. Alternatively, asynchronous techniques can be used as well, in combination with a free running clock (ring oscillator) with a divider and gating.

In an embedded computing system according to the present invention, an amplifier may be provided for amplifying the generated first or second internal operating clock signal.

Furthermore data communication channels may be provided between at least some of the processing elements. This allows processing elements to communicate with each other. Each processing element may be connected to all its nearest neighbors by means of data communication channels. This provides more flexibility, because communication channels which are not necessary for one configuration may be necessary for another configuration. If communication channels between all neighboring processing elements are provided, more configurations may be possible.

A level-shifting device may be provided within a data communication channel between two processing elements. This allows communication between processing elements on different power supply levels. The level-shifting device may be configurable so as to be able to handle the power supply level range associated with the different supply rails provided in the computing system. A same level-shifting device can then be used in case the processing elements are reconfigured to run with a different power supply level.

The present invention also provide a method for reconfiguring an embedded computing system comprising a plurality of domains, each domain comprising at least one processing element, each domain operating at a utility supply value, one domain operating at a first utility supply value, wherein reconfiguration is done during operation of the computing system. The method comprises independently changing the utility supply value to a second utility supply value for the one domain. This allows to achieve optimal trade-offs between performance and energy consumption during the lifetime of the device.

The utility supply value may be a power supply value. The method may comprise: independently changing to a second power supply value for the one domain by switching between a plurality of power supply rails carrying different power supply levels.

Additionally, or alternatively, the utility supply value may be a clock frequency. The method may comprise generating, for each domain, an internal operating clock signal from a reference clock signal supplied to each of the domains, the internal operating clock signals of at least two domains being different from each other, the generation of the internal operating clock signal being reconfigurable during the life-time of the embedded computing system.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 illustrates an example of a prior art embedded computing system with hard-wired clock and power supply value distribution.

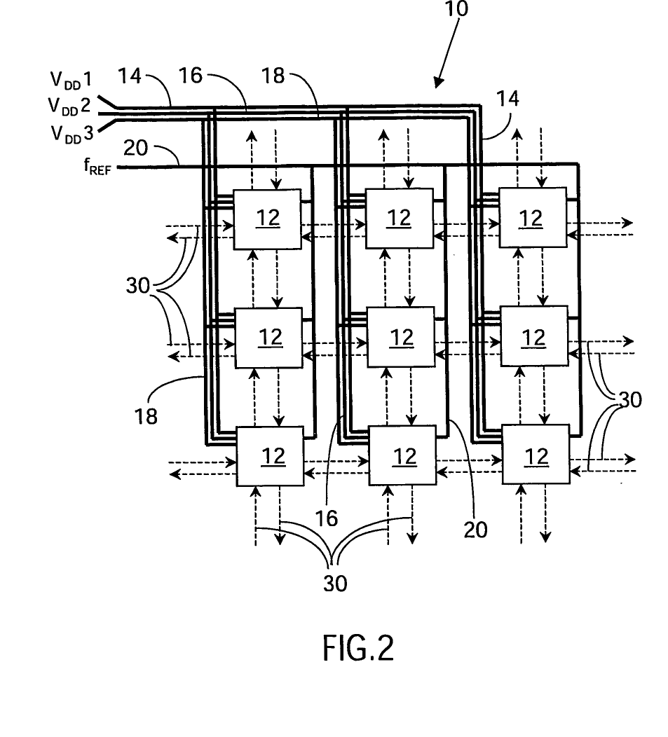

FIG. 2 illustrates one embodiment of an embedded computing system according to the present invention, wherein the embedded computing system comprises a regular grid of processing elements, with configurable clock and power supply value.

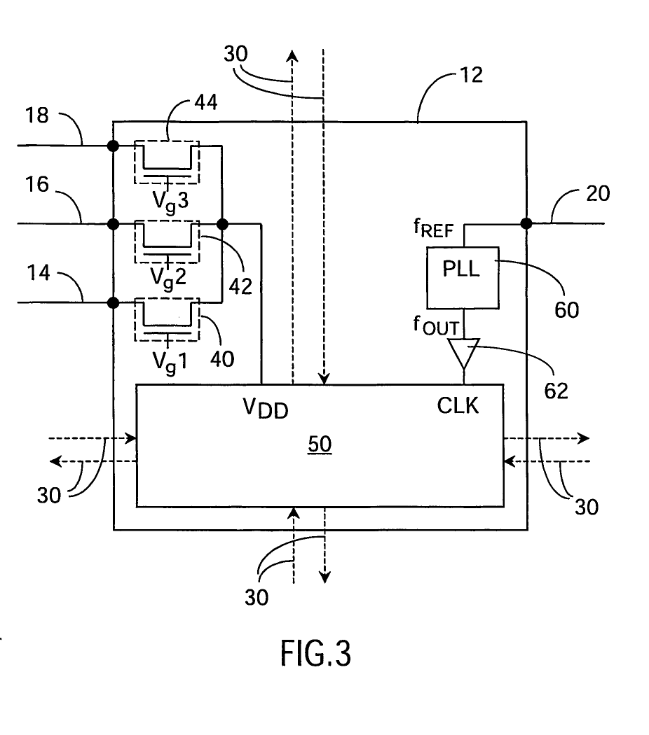

FIG. 3 is an embodiment of a detailed implementation of a processing element, showing a possible way to configure its clock and power supply value.

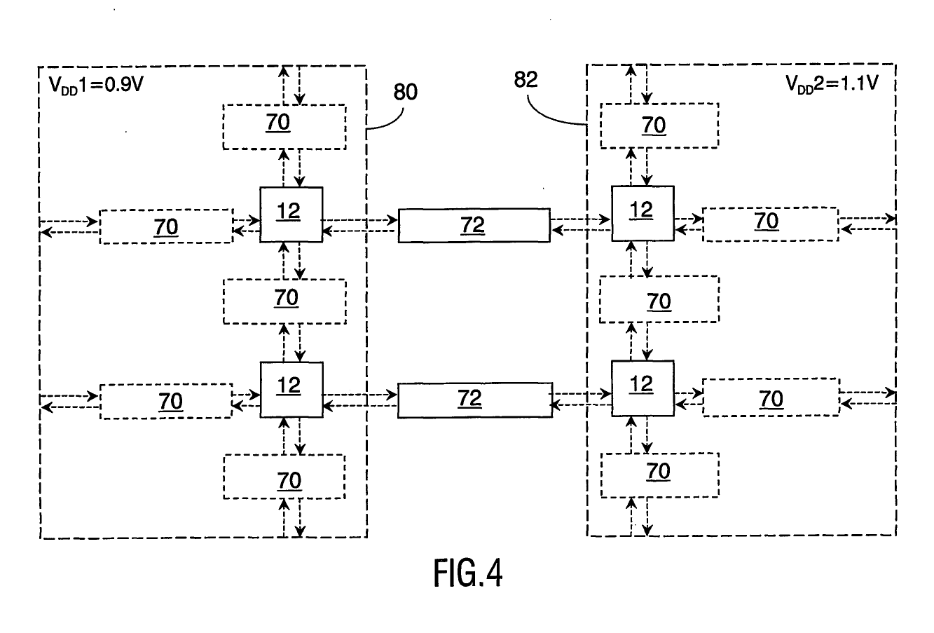

FIG. 4 illustrates the use of level shifting devices in data communication channels between processing elements to allow processing elements running at different power supply levels to communicate to each other.

In the different drawings, the same reference figures refer to the same or analogous elements.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

FIG. 2 illustrates schematically an embodiment of an embedded computing system 10 with a flexible, field-programmable definition of clock and power supply domains according to the present invention. The embedded computing system 10 comprises a plurality of processing elements (PE's) 12. In FIG. 2, the processing elements 12 are shown as boxes arranged in a regular grid. An irregular layout is also possible, although not represented in the drawings. The processing elements 12 can be for example, but not limited thereto, a programmable processor or DSP, a Field Programmable Gate Array (FPGA), Programmable Array Logic (PAL), a Programmable Logic Array (PLA), an ASIC core, a block of memory (e.g. RAM) or other state-holding element (e.g. a Register File), a reconfigurable core, or any combination thereof. Preferably, the processing elements 12 in the grid are identical, but that is not a requisite. Identical processing elements 12 facilitate scalability. If a bigger design is to be made, that can be fast and easily accomplished simply by increasing the number of PE's 12. In addition, identical processing elements 12 allow for a homogeneous circuit that is more general-purpose than heterogeneous circuits wherein local irregularities need to be considered when mapping an application.

Multiple voltage supply rails 14, 16, 18 are provided throughout the grid. Each voltage supply rail 14, 16, 18 is associated with a different power supply, in the example given with values V_{DD}1, V_{DD}2 and V_{DD}3, respectively. In FIG. 2, three different voltage supply rails 14, 16, 18 are illustrated. However, another number of power supply rails is also possible.

A global reference clock line 20 for carrying a reference clock signal fREF is also distributed throughout the grid. The frequency of this reference clock line 20 should preferably be less than or equal to the lowest clock frequency that might be required anywhere in the grid, i.e. in any of the processing elements 12 on the grid.

The processing elements 12 can communicate to each other via data communication channels 30, represented in FIG. 2 as dashed arrows. The collection of all communication channels 30 in the grid makes up a so-called communication network. FIG. 2 illustrates a grid wherein each processing element 12 is connected to all its nearest neighbors, making up a regular communication network. Communication networks with irregular patterns are also possible, although not preferred for flexibility reasons.

FIG. 3 illustrates a processing element 12 according to the present invention in more detail. It is explained how a processing element 12 in the grid can configure itself to use one of the multiple supply voltages V_{DD}1, V_{DD}2 or V_{DD}3 available to it on the different voltage supply rails 14, 16, 18. A number of input switching elements 40, 42, 44, equal to the number of voltage supply rails 14, 16, 18 is used (three, in FIG. 3). The input switching elements 40, 42, 44 may be, for example, solid-state switches such as transistors. With each input switching element 40, 42, 44 is associated a switching signal, which will close or open the switching element 40, 42, 44 and thus make it conductive or not In case of the switching elements 40, 42, 44 being transistors for example, then with each transistor is associated a given gate potential (V_{g}1, V_{g}2, and V_{g}3 respectively, in FIG. 3), and setting one of the gate potentials to an appropriate value polarizes one of the transistors, thus passing on the associated supply voltage to computing and communication resources 50 (e.g. function units, register files, multiplexers, internal communication networks, memories, etc.) of the processing element 12. A scheme analogous to the configuration memory of e.g. FPGAs can for example be used to control the switching signal of the switching elements 40, 42, 44, e.g. the gate potentials of the input transistors (this is not shown in FIG. 3). For instance, an SRAM memory cell can be associated to the gate of each transistor 40, 42, 44, either directly, or through some auxiliary electric components that can translate the value stored in said memory cell into an appropriate polarizing voltage to be applied to the transistor gate. If a logic value “0” is stored in said memory cell, the gate is not polarized and the switch is in open state. If the logic value “1” is stored in said memory cell, then a gate potential is applied to the transistor, closing the switch, and passing on the supply voltage to the resources 50.

The set of all memory cells (one associated to each transistor 40, 42, 44 in each processing element 12 in the entire system) can be looked at as a configuration plane analogous to those used in FPGA's. This allows the embedded computing grid to be field-configurable at an electrical level.

Preferably all power supply rails 14, 16, 18 run to all PE's 12, because it is not known in advance how many domains there will be, nor which PE's will be in which domain. To preserve flexibility of the architecture, the hardware preferably is such that each PE can make its supply power choice independently from each other PE. After device fabrication, a programmer can define different domains arbitrarily, by programming the choice of supply power to be identical in all PE's belonging to a domain. By bringing all supply rails to all PE's in the hardware, the arbitrary post-fabrication definition of domains at a PE-level of granularity is allowed for.

FIG. 3 also shows how a processing element 12 can configure its own operating clock signal (clock signal self-configuring processing element) based on the reference clock signal with frequency f_{REF} available on the global reference clock line 20 in the grid. A frequency adapter 60 is provided in the processing element 12 for deriving a desired internal operating clock signal with frequency four from the reference clock signal with frequency f_{REF}. For example a Phase-Locked Loop (PLL) may be used as frequency adapter 60 to multiply the frequency f_{REF} of the reference clock signal by a factor, thus generating the internal operating frequency four of the processing element 12. Any other frequency adapter 60 which does not introduce substantial phase shifts between the in-going and out-going clock signals can also be used. This way, a processing element 12 with field-configurable operating frequency is provided. It is to be noted that the phase of the internally generated clock signal f_{OUT} is ideally the same as that of the reference clock signal f_{REF}, although small discrepancies can be tolerated.

An amplifier 62 may optionally be introduced for amplifying the generated internal operating clock signal, depending on the load associated to the computing and communication resources 50.

Since each processing element 12 according to the embodiment described can be field-configured to use a particular clock frequency and/or power supply level (V_{DD}), they may be referred to as configurable clock and V_{DD} islands.

Because there can be a phase-shift in the reference clock signal with frequency F_{REF} received by processing elements 12 that are physically distant from each other in the grid, due to wire delay, synchronization problems can occur if those two distant processing elements 12 were to communicate directly with each other. The phase-shift in the reference clock signal with frequency f_{REF} received by processing elements 12 that are physically close together, however, should be negligible. Therefore, it is preferred that the data communication network in the grid favor local, short-distance data communication channels, instead of longer-distance ones.

By configuring a sub-set of processing elements 12, preferably neighboring PE's 12, to use a common power supply level, and/or a clock signal with a common clock frequency, a domain is formed. Multiple clock and power supply level (V_{DD}) domains can be dynamically configured, and reconfigured, in the grid, after device fabrication. A sub-set of PE's 12 comprises at least one of the PE's. A domain thus consists of a sub-set of (preferably neighboring) processing elements 12 in the system configured to run at a common power supply level and/or clock frequency. The configuration of power supply levels and/or clock frequencies, however, takes place at individual processing element level.

In the embodiment explained with respect to FIG. 3, both the supply voltage V_{DD} and the clock frequency are reconfigurable. However, according to the present invention, processing elements 12 with either of the power supply level or the clock frequency being reconfigurable are also part of the present invention.

When processing elements 12 from two different power supply level V_{DD} domains, configured according to the present invention as explained above, need to communicate to each other via the data communication network, configurable level shifting devices 70, 72 may be needed within the data communication channels 30, so that the different voltage levels on the two ends of a channel 30 can be harmonized during the communication. This is represented in FIG. 4. The level shifting devices thus should be configurable for a limited number of situations corresponding to the different power supply levels V_{DD}. The level shifting devices 70 should be configurable so as to be able to handle the voltage range associated to the different voltage supply rails 14, 16, 18 provided for in the grid. For example the level shifting devices may comprise a number of blocks, e.g. three blocks, which internally are not reconfigurable, and between which is switched. Alternatively, a level-shifting device can be made reconfigurable by using a configurable bias current. A digital-to-analog converter may for example be used to set this bias current. This may be costly compared to the cost of the level-shifting device itself, but this control can be shared by a group of level shifting devices. According to still another embodiment, for example a level-shifting device which is a variant of U.S. Pat. No. 4,486,670 may for example be used. This level-shifting device works both ways, for shifting from a high to a low V_{DD} level and for shifting from a low to a high V_{DD} level. For example a standard 12-transistor level shifter circuit per level may be used.

Although level shifting devices 70, 72 are present in all data communication channels 30 in FIG. 4 (for the hardware to be flexible), only the ones in between different voltage supply domains are active. In FIG. 4, two voltage supply domains 80, 82 are represented, the first voltage supply domain 80 using a first voltage supply rail at 0.9 volt, and the second voltage supply domain 82 using a second voltage supply rail at 1.1 volt All level shifting devices 70 within the first voltage supply domain 80 are inactive, and all level shifting devices 70 within the second voltage supply domain 82 are inactive, while the level shifting devices 72 on the communication channels 30 between the first voltage supply domain 80 and the second voltage supply domain 82 are configured and active.

It is to be understood that although preferred embodiments, specific constructions and configurations, as well as materials, have been discussed herein for devices according to the present invention, various changes or modifications in form and detail may be made without departing from the scope and spirit of this invention.

1. An embedded computing system (10) comprising a plurality of domains, each domain (80, 82) comprising at least one processing element (12), each domain (80, 82) operating at a utility supply value, one domain (80, 82) having a first utility supply value, wherein each processing element (12) of the one domain is provided with a reconfiguration device for independently changing the utility supply value to a second utility supply value for the one domain.

2. An embedded computing system (10) according to claim 1, the utility supply value being a power supply value.

3. An embedded computing system (10) according to claim 2, wherein a plurality of power supply rails (14, 16, 18) carry power with different power supply values (V_{DD}1, V_{DD}2, V_{DD}3) to the processing elements (12) of at least one of the domains (80, 82), each processing element (12) of the at least one domain (80, 82) being provided with a switching element (40, 42, 44) for independently making a connection to a power supply rail to change the power supply value to from a first power supply value to a second power supply value.

4. An embedded computing system (10) according to claim 2, wherein the switching element is a transistor.

5. An embedded computing system (10) according to claim 1, the utility supply value being a clock signal.

6. An embedded computing system (10) according to claim 2, the utility supply value being a clock signal.

7. An embedded computing system (10) according to claim 5, wherein the computing system comprises a global reference clock line (20) carrying a reference clock signal (f_{REF}) to the processing elements (12) of at least one of the domains (80, 82), each processing element (12) of the at least one domain (80, 82) being provided with a frequency adapter (60) for generating from the reference clock signal (f_{REF}) a first internal operating clock signal (four) for the one domain (80, 82), the frequency adapter (60) being reconfigurable for independently generating from the reference clock signal (f_{REF}) a second internal operating clock signal (f_{OUT}).

8. An embedded computing system (10) according to claim 7, wherein the reconfigurable frequency adapter (60) is a PLL.

9. An embedded computing system (10) according to claim 7, wherein an amplifier (62) is provided for amplifying the generated first or second internal operating clock signal (f_{OUT}).

10. An embedded computing system (10) according to claim 1, wherein data communication channels (30) are provided between at least some of the processing elements (12).

11. An embedded computing system (10) according to claim 10, wherein each processing element (12) is connected to all its nearest neighbors by means of data communication channels (30).

12. An embedded computing system (10) according to claim 10, wherein a level-shifting device (70, 72) is provided within a data communication channel (30) between two processing elements (12).

13. An embedded computing system (10) according to claim 12, wherein the level shifting device (72) is configurable so as to be able to handle the power supply level range associated with the different supply rails provided in the computing system.

14. A method for reconfiguring an embedded computing system (10) comprising a plurality of domains (80, 82), each domain comprising at least one processing element (12), each domain operating at a utility supply value, one domain (80, 82) operating at a first utility supply value, wherein reconfiguration is done during operation of the computing system, the method comprising: independently changing to a second utility supply value for the one domain (80, 82).

15. A method according to claim 14, the utility supply value being a power supply value.

16. A method according to claim 15, further comprising: independently changing from a first power supply value to a second power supply value for the one domain (80, 82) by switching between a plurality of power supply rails (14, 16, 18) carrying different power supply levels.

17. A method according to claim 14, the utility supply value being a clock frequency.

18. A method according to claim 15, the utility supply value being a clock frequency.

19. A method according to claim 17, further comprising: generating, for each domain, an internal operating clock signal (f_{OUT}) from a reference clock signal (f_{REF}) supplied to each of the domains, the internal operating clock signals (f_{OUT}) of at least two domains being different from each other, the generation of the internal operating clock signal being reconfigurable during the life-time of the embedded computing system (10).
